(19) United States
(12) Patent Application Publication
(10) Pub. No.: US 2026/0287113 A1
(43) Pub. Date: Sep. 24, 2026

(54) Quick Mounting and Self-Latching Methods for Fold Flat Support Structure Assemblies

(71) Applicant: Richard N Shapiro, Virginia Beach, VA (US)

(72) Inventor: Richard N Shapiro, Virginia Beach, VA (US)

(21) Appl. No.: 19/083,527

(22) Filed: Mar. 19, 2025

(51) Int. Cl. F16M 13/02; F16C 11/04

(52) U.S. Cl. CPC F16M 13/02; F16C 11/045; F16M 2200/021

(57) ABSTRACT

This application discloses folding support structure assemblies with quick connect methods, so the end user may mount the previously constructed folding support sub-assembly components rather than have these parts constructed and mounted to a supported article in a factory, with simple quick manual movement of a pivot retainer, a support assembly (with a support, wheel, ski, etc.) is mounted or dismounted from bilateral pivot openings. A second innovation is a folded position release finger tab, which autonomously latches the entire assembly when swept to the second, stowed position. Shaped portions of the finger tabs act in concert with two separate pathways formed along at least one end of a horizontal pivot, and moving the finger tab release allows movement of the support assembly from the stowed position back to the operative, use position without springs or parts besides the finger tab.

### RELATIONSHIP TO OTHER APPLICATIONS

This application does not relate to any prior applications filed by this applicant; however, it provides for novel methods relating to fold-flat support-structure assemblies that the inventor previously outlined and disclosed in prior U.S. Pat. Nos. 9,193,368, and 7,819,408. This current application provides novel methods to pre-construct a subassembly of a fold-flat support structure assembly, which can be mounted by a consumer or any user in a set of bilateral pivot-receiving holes or openings, and one side includes a novel manually releasable pivot retainer which serves to fixate one side of the pivot. A second innovation outlined in this application relates to a novel latch and release method so that the support-structure assembly autonomously latches when moved to the folded position inside the article's perimeter, and to release the assembly from the second, stowed position, the user presses the finger tab, which frees the folded support-structure assembly from a latched position folded inside the article, and allows the user to freely rotate the folding support-structure assembly back to the operative position supporting the article. These innovations are in the form of a shaped area of the finger tab and corresponding pathways formed in the support pivot, as outlined in detail in this application.

### FIELD OF THE INVENTION

This application relates to novel support structures, which may be swept and folded into a flat profile inside and/or closely adjacent to an article or receptacle, widely applicable to support structures in United States Class 248, and its international class equivalent, and additionally applying to folding aspect for wheeled vehicles likes wagons and carts. The support-structure assemblies provide for a shaft, mounted to an article, generally perpendicular to the ground surface in an operative position, including several simple mechanisms described in the application that allow the support structure assembly and the support shaft to be rapidly and conveniently moved and compactly stowed, so that the support structure assembly and support shaft is in a plane near to parallel to the side elevational profile of the overall supported article. Accordingly, the support shaft and support structures disclosed provide for a compact stowed position of the support structure assembly, within the perimeter of the horizontal frame and side elevational profile of the supported article. These support-structure assemblies and their folding attributes are widely applicable to stationary objects, articles and receptacles, as well as to vehicles with running gear, wheels, sliding portions or skis. Building on the applicant's previous patents, disclosed above, this new application provides a quick mounting and dismounting method for a fold-flat support-structure assembly allowing a consumer or user to rapidly mount the entire support-structure assembly, including its support shaft, into bilateral openings in the supported article through which a pivot is mounted. The second innovation is the novel method that autonomously latches the folded support-structure assembly when moved to the stowed position, and to move the assembly and support shaft from the stowed position, a user pushes a finger tab momentarily, which allows for the unlatching of the folded support-structure assembly and for its pivot and rotation into an operative position orthogonal to the side elevational profile and supporting the article through a second latching means.

### BACKGROUND OF THE INVENTION

This invention relates to stowable or fold-flat support structures, which can be for stationary articles, wheeled vehicles, vehicles with skis or sleds as well. Many of the applicant's prior United States patents in one way or another relate to fold-flat support structures and/or wheel structures, including prior U.S. Pat. Nos. 9,193,368; 7,819,408; and 7,066,485 among others. One reason that the applicant developed the novel features described here is that the original design that applicant outlined in U.S. Pat. No. 9,193,368 required construction of the inner-working parts of the support-structure assembly “in place”, meaning that any constructor would have to first run a plastic case through a pivot where it would await constructed parts, such as the vertical support-structure shaft, a latch block dropped onto the vertical upper portion of the support shaft, the spring, the circlip would be then placed and after those inner sub-assemblies parts were placed, then the vertical support shaft would have to be placed inside and upwards through the plastic case, also pressed upwards through the horizontal pivot, and then a terminal fixing nut would be placed. All those steps had to be done in place at the supported article. Accordingly, one of the primary reasons for the current application was to solve this construction issue, and allow for complete construction of the fold-flat support assembly in a factory setting and allow the parts to be shipped to a consumer, where the consumer can quickly mount the sub-assembled fold-flat support-structure assemblies into bilateral pivot openings for however many support structures an article required, or for wheeled or movable devices, the support shaft design allows the consumer to also mount a wheel, sled or ski to the supported device, among myriad other applications.

Secondly, another limitation of the applicant's prior art was that latching a fold-flat support-structure assembly inside the supported article required spring biasing with springs or the addition of separate latching components. One method involved use of a sheet spring; other designs used a slide pin also to secure the structural support assembly in the stowed position. This application provides for a simpler “automatic” latching method for the support-structure assembly in the fold-flat position, such that the innovation requires no spring, and this application discloses what is referred to as a support-structure assembly folded position finger tab release. The attributes that are preferred are explained in this application in further detail.

### SUMMARY OF THE INVENTION

This application provides for quick connect compact, stowable “fold-flat” support-structure assemblies that include a support shaft stand (which can also include a wheel, a ski, or a foot for a stationary position) so that an article is maintained in a spaced relationship from another surface in a first, operative position, and in a second, stowed position the support-shaft stand is moved substantially inside the side elevational profile of the article. Improvements include a releasable pivot retainer that specifically allows a user or consumer to mount the support-structure assembly quickly and easily into bilateral pivot openings in the supported article. In addition, although the releasable pivot retainer is intended to be semi-permanent, a user can easily remove the sub-assembled support-structure assembly by manipulating the releasable pivot retainer, which allows one side of the pivot of the support-structure assembly to be moved in or out of an elongate bracket opening, thereby allowing the user to manipulate and remove the sub-assembly from the supported article. Another innovation of the application discloses a stowed position finger tab which acts in concert with at least two differing length pathways formed in the exterior of one side of the horizontal pivot. When the user moves the support structure assembly from the first, operative position into a stowed position inside the perimeter of the article, the novel finger tab self-latches automatically because the mounting of the finger tab urges the finger tab inwards toward the center of the pivot which orients a shaped portion of the finger tab into a short length pathway that is formed into the exterior of one end of the pivot, holding the support assembly and shaft in the stowed position. Simple manual manipulation of the same finger tab positions a shaped portion of the finger tab in a free rotation pathway formed from the exterior near the end of the pivot thereby allowing the support shaft to be moved from the stowed, back to the operative position.

### BRIEF DESCRIPTION OF THE DRAWINGS

There are a total of seven drawing figures.

FIG. 1 is a slightly elevated, side-elevational view of a cutaway portion of the supported article wall structure, showing a support-structure assembly bracket, the support-structure assembly (which hides the internal components of the optional case in this figure) and reveals the support-structure shaft mounted vertically through the inside of the support-structure assembly. While these figures show an assembly case and a latch block, it is appreciated that the innovations may be embodied without any support case, and without a latch block mounted along the support shaft. The latching may be accomplished in numerous other ways, and no assembly case is necessary in such situations.

FIG. 2 is a side-elevational profile of the support-structure assembly bracket and reveals parts normally hidden inside the plastic case, which is shown exploded away from the subassembly and the U bracket in FIG. 2.

In FIG. 3 is shown a side-elevational profile of a portion of the walls of a supported article, revealing an exploded view of the quick connect pivot retainer, also indicating where that retainer is mounted in its operative latched position in an inner aspect of the bracket of the support structure assembly, which is shown here in the folded, stowed position with only the pivot placed through the support case.

In FIG. 3-B is shown a side elevational profile of a portion of the walls in an exploded view, which is merely a variant of FIG. 3, detailing a slight variation of the pivot retainer, 21 as far as how it secures to the U-shaped support structure assembly bracket.

In FIG. 3-C is shown a side elevational profile of a portion of the walls in an exploded view, which is yet another variant of FIG. 3, detailing a slight variation of the pivot retainer, 21 as far as how it secures to the U-shaped support structure assembly bracket.

In FIG. 4 there is a cutaway view of the side elevational profile of a supported article showing the support structure assembly in the folded position and for ease of visual understanding, the pivot is exploded away from the primary view to reveal the special pathways and channels in one side of the pivot and showing a clear view, exploded, of the folded position support structure assembly release finger tab (26).

In FIG. 5, a close-up, exploded view is shown of one end (30) of the pivot (3), surrounded by the finger tab (26), focusing on the inward facing projections, (27) movement of which provides for unlatching of the pivot when it's moved from the stowed position back to an operative position of the support structure assembly.

### BRIEF DESCRIPTION OF THE PREFERRED EMBODIMENT

Referring to the drawings, the following are descriptions of the numbered elements:
1. Article support base-cut away.
2. Support structure assembly bracket
3. Pivot
4. Support structure assembly bracket bilateral pivot openings
5. Support structure assembly case
6. Support structure assembly support shaft
7. Support structure assembly case latch block retention opening
8. Support structure assembly latch block
9. Latch block ears
10. Circlip
11. Spring
12. Latch block partial central opening
13. Support, structure assembly, pivot central support shaft opening
14. Support shaft terminal fixing nut
15. Support structure assembly under pivot rectangular recess
16. Support structure under pivot, optional square nut (prevents shaft rotation) (not shown)
17. Support structure assembly finger grip
18. Support structure assembly case guide ridges
19. Elongate support structure assembly pivot openings
20. Support structure assembly support shaft nut access hole
21. Releasable pivot retainer
21-B elongate bracket pivot opening
22. Pivot retainer, mounting arm
22-B pivot retainer mounting arm rivet
23. Pivot retainer finger grip
24. Pivot retainer latching hole
25. Pivot retainer latching protrusion
26. Folded support structure assembly release finger tab
27. Support structure assembly release tab (for pivot) shaped latching projections
28. Support structure assembly release tab-mounting fasteners
29. Support structure assembly release tab-mounting fastener holes
30. Shaped pathway track areas, one end of pivot
31. Pivot latched/folded position fixed position shaped pathway
32. Pivot free rotation shaped pathway
33. Pivot retainer with raised lower edge
34. Support structure assembly bracket recessed pathway
35. Pivot retainer with retention opening
36. Pivot retainer retention projection

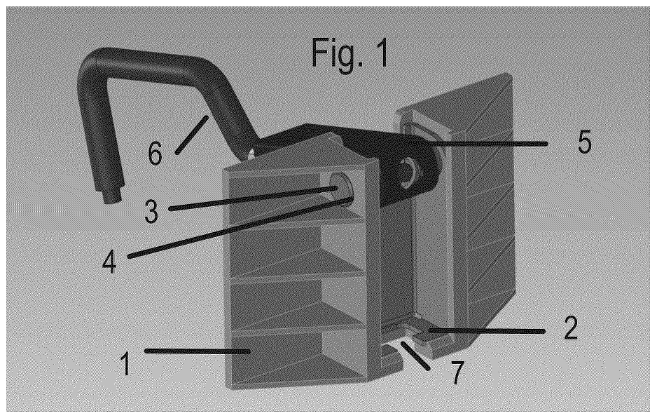

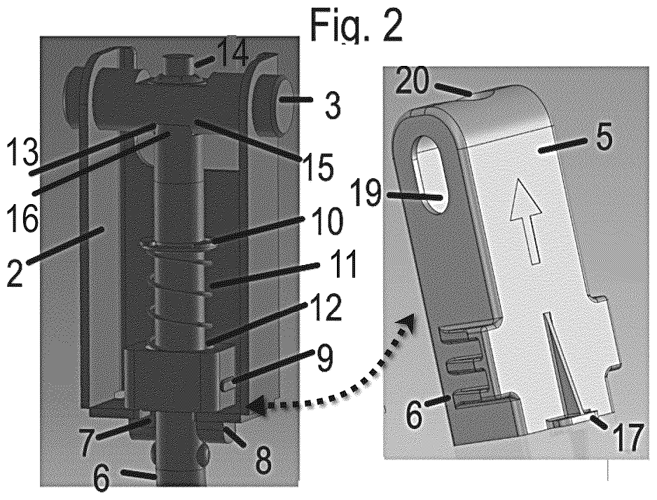

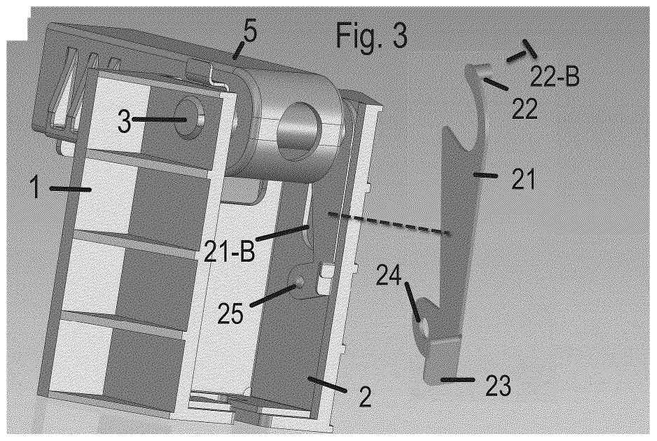

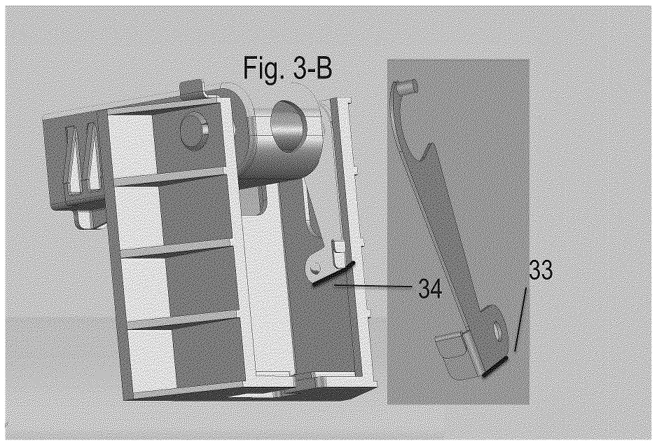

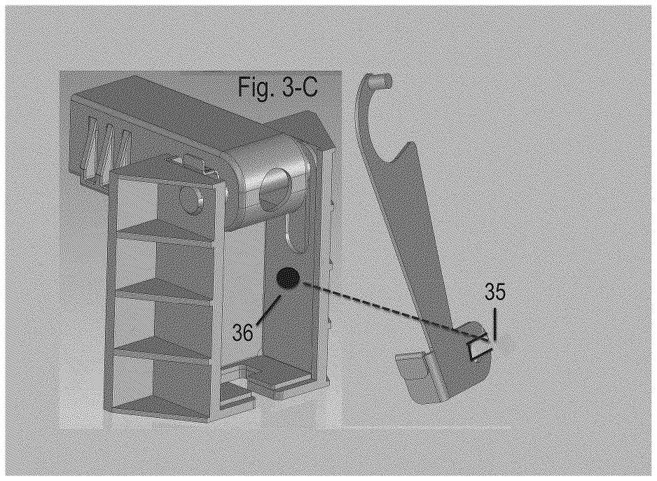

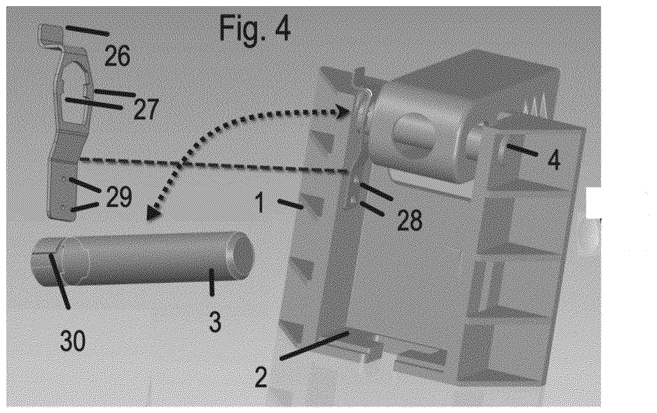

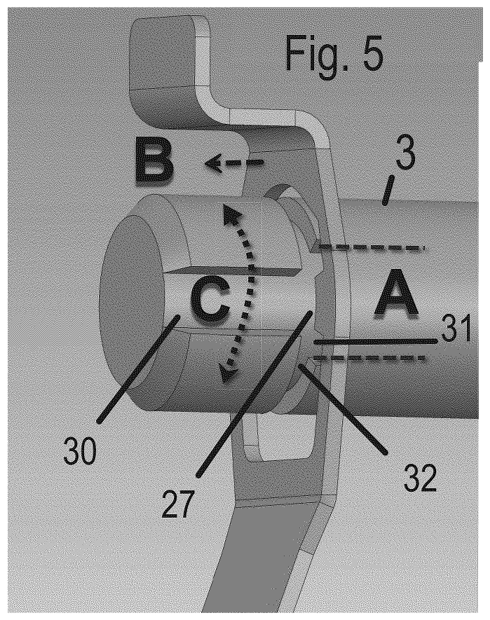

Referring first to FIG. 1, which is a cut-away view of the side elevational profile of the article support base, 1. The U-shaped support structure assembly bracket, 2, is shown in a mounted position in a recess or channel created towards the outer perimeter of the supported article. The assembly bracket, 2, forms a part of the supported article once secured to the article, and it is appreciated that the bracket may instead be wholly eliminated with appropriate strength of the article perimeter, allowing for both the pivot retaining tab and the self-latching stowed position finger tab (discussed in detail below) to be mounted directly to the support article rather than to the support bracket, 2. The support structure assembly features a pivot, 3, which serves to mount the support structure assembly case, 5, as well as the support structure assembly support shaft, 6. The pivot mounts through support structure assembly bracket bilateral pivot openings, 4, one of which is shown in this view. FIG. 1 shows the existing state-of-the-art prior to the innovations outlined in the other figures. One of the limitations shown in FIG. 1 is that the support structure assembly case, 5, must be mounted in one distinct way: that is that the support structure shaft, 6, has to be fed up through the parts mounted inside the support case, 5, after the pivot, 3, is situated and placed through the bilateral pivot openings, 4, and a terminal fixing nut (shown in FIG. 2), is placed after the overall parts are constructed once the pivot is mounted horizontally as described above. The main object of this invention is to eliminate the need to construct the entire support structure assembly parts and case in place with the pivot already mounted through the holes, 4. This innovation of the present application will be more clearly described in FIGS. 3-5.

Next, referring to FIG. 2, this figure shows all the inner parts of the support structure assembly, and it will be appreciated how the entire assembly must be fabricated in place with the pivots slid through the bilateral pivot openings, 4 prior to the innovations disclosed in FIGS. 3-5. In FIG. 2, is shown a support structure assembly support shaft, 6, which travels vertically inside the assembly. In FIG. 2, the support structure assembly latch block, 8, is slid down onto the support shaft, 6. followed by the spring, 11, which is pressed downwards to the upper recessed round receiving portion within the top of the latch block and then a circlip, 10, is fixed into the mid-section of the support shaft, creating a spring biasing effect downwards on the latch block, 8. As shown in FIG. 2, the latch block, 8, is spring biased downwards through the support structure assembly case latch block retention opening, 7. When the latch block is down into the retention opening, 7, surrounded by the support structure case 5, the overall structural assembly is latched in the operative position supporting the article, which can be supported with a tire, a fixed foot, or any other suitable movable item, whether one that slides, rolls or one that's fixed along the surface or ground.

Further referring to FIG. 2, the underside of the pivot, 3, has an under-pivot rectangular recess, 15, the purpose of which is to accommodate either 360 degrees rotation of the support shaft along its axis, if the support shaft is interconnected to a tire for example, which is intended to freely rotate and turn along a rolling surface. However, through the simple addition of a square washer 16 (not shown exploded away from the support shaft in FIG. 2) that is slid down over the support shaft prior to when the support shaft is pressed upwards inside the pivot, 3, this simple method provides for fixation of the support shaft against movement along its vertical axis, or if that additional square washer is not placed, the support shaft can rotate 360 degrees along the vertical axis.

It bears mention that the full construction sequence of the applicant's prior art structural support assembly is as follows, the plastic case 5 is slid centrally on to the horizontal pivot 3, the pivot is first placed into the horizontal bilateral support structure bracket case pivot openings 4, then all the internal parts are mounted onto the support shaft 6, and only then is the support shaft vertically pressed upwards through the support case 5, and the shaft 6 is fixated inside the case by the bilateral ears 9 which are captured in corresponding bilateral openings formed on the lower sides of the case 5, and the terminal fixing nut 14 is then forced down over the support shaft 6, through an opening at the top of the support case 20 (nut access hole) securing the structural support assembly so that it may latch in the operative position inside the support case bracket 2. When the support structure assembly is in the operative position the latch block which forms the bottom of the support structure assembly case, 5, is spring biased to fit down into the case latch block retention opening 7. To move the support structure assembly from the operative, in use position described, the user pushes upwards on the finger grip on the lower end of the case, 17, which moves the latch block, 8, upwards to where it is freed from the corresponding latch block retention opening area, 7, allowing the support shaft and the entire assembly to be pivoted to an area generally inside the perimeter of the supported article. The other figures, FIGS. 3-5, explain how the support structure assembly is latched in an inwards folded position between 250 and 290 degrees away from the operative position. Also, in FIG. 2, are shown bilateral ridges on both sides of the support case, 5, these ridges 18 serve to guide the case 5 into the operative position inside the support structure assembly bracket, 2. As mentioned above, FIGS. 3 through 5 describe the innovations and improvements over applicant's own prior art which are the focus of this application.

In FIG. 3, is shown what is referred to as a (quick connect) releasable pivot retainer, 21. The purpose of this releasable pivot retainer, 21, is to eliminate the need to construct and build all internal parts of the structural support assembly “in place” with the pivot 3 already mounted through the bilateral pivot openings 4 as discussed in explaining FIG. 2. A key feature of the invention is to allow the entire support structure assembly case and pivot to be constructed separately (sub-assembled) and sequenced prior to the mounting of the horizontal pivot into the support case bracket 2. This innovation is accomplished through the releasable pivot retainer, 21, which in a first, latched position is fixed to the support bracket 2 by the pivot retainer mounting arm 22, which passes through a corresponding hole in an upper aspect of the support bracket 2 (the small hole is not visible in FIG. 3) and secured to the bracket by a mounting arm fixing pin rivet (22-B) which permits the pivot retainer to pivot or move along the mounting arm 22 and the pivot retainer 21 serves to close off an elongate bracket pivot opening, 21-B. The elongate pivot opening is formed out of one side only of the support bracket 2 and accommodates the placement of the already constructed structural support case 5, including the pivot 3, and the support shaft 6 with all internal parts already mounted and constructed. As stated earlier, the support bracket, 2, forms a part of the supported article once mounted, and depending on strength and materials of the supported article, the bracket 2 may even be eliminated so that the pivot retainer 21 is instead mounted directly to the supported article instead.

In FIG. 3, the releasable pivot retainer, 21, is shown in the latched position where it holds the pivot and the support structure assembly in place and the same releasable pivot retainer, 21, is showed in an exploded view that details the shape and nature of this part, which includes a pivot retainer mounting arm, 22, a pivot retainer finger grip, 23, and a pivot retainer latching hole, 24, which corresponds with a pivot retainer latching protrusion, 25. Before the structural support assembly case, 5, including all of its associated internal parts are mounted to the supported article, the innovations disclosed herein provide for all those parts inside the case, including the horizontal pivot, to be constructed first, prior to any placement of the fold flat structural support to be mounted in the supported article bilateral pivot openings discussed earlier. Instead, the fully constructed assembly and the pivot would be put in one side of the bracket, 2, as one end of the bilateral pivot openings would be round but the opposite side of the bracket, 2, would feature an elongate opening, referred to as 21-B in FIG. 3. The releasable pivot retainer itself pivots along the pivot retainer mounting arm, 22, which slides into a corresponding hole or opening in the metal bracket, 2 (the hole is not shown in FIG. 3) and the pivot retainer mounting arm may be secured snug to the metal bracket 2 opening/hole with a rivet. Thus, the releasable pivot retainer, 21, pivots about the mounting arm, 22, and the releasable pivot retainer, 21, is pivoted downwards in relation to the fixed mounting arm, 22, and into and over the inner aspect of the metal bracket 2 serving to close off the elongate bracket opening 21-B, and is captured and secured against movement on one of more pivot retainer latching protrusions, 25, securing it in the operative/closed position, which thereby secures one side of the pivot 3 securely against vertical movement in the support bracket side with the opening that has the elongated shape, at 21-B. This is a semi-permanent latched position of the releasable pivot retainer, 21, but if the user needs to release the retainer, 21, the user can do so by virtue of manipulation of the finger tab, 23, that is formed at the lower portion of the releasable pivot retainer, 21. Pulling on the finger tab away from the rear of the support structure assembly bracket, 2, and then upwards reveals the elongate opening 21-B and allows a user to remove the pivot and the support assembly case 5 and its internal parts, if some type of modification or repair becomes necessary. The object of the innovation is to allow the completely constructed structural support sub-assembly and pivot to be mounted as a unit before and away from the supported article, before the final mounting process, and the innovations here may be used with no outer “case” at all, and the latching block embodiment is not necessary for the main innovations to still provide for the novelties disclosed here.

Both FIGS. 3-B and 3-C are variations of the features shown originally in FIG. 3 but each call for a slight variant embodiment of the pivot retainer, 21 regarding its securement to the support bracket 2. In FIG. 3-B, is shown a pivot retainer with a protruding or raised lowered edge, 33, which when pivoted to the latched position matches a corresponding recess, 34, along the U shaped support assembly bracket so that the recess 34 is a securing pathway for the pivot retainer's raised lower edge, to not only guide the pivot retainer toward the securement against the U shaped bracket but also to provide some further support for the pivot retainer along with the raised projection shown in FIG. 3, indicated at 25 (in FIG. 3). FIG. 3-C shows yet another securing variation for the pivot retainer 21, whereby this pivot retainer includes a retention opening indicated at 35 and when the pivot retainer is pivoted into the latched position with the support bracket 2, the retainer opening shown at 35 secures snugly with a matching shaped pivot retainer retention projection 36, fashioned along a raised portion of the inner aspect of the U shaped support bracket, 2. It is appreciated that rather than an opening at the lower portion of the pivot retainer arm 21, a shaped portion of the lower bracket may secure the pivot retainer arm by sliding over an inverse shaped protrusion on the metal bracket.

Referring now to FIGS. 4 and 5 together, these figures describe another innovation of the current application, which provides for a simple method to latch the overall support structure assembly in a folded latched position “automatically” (without user manipulation of any parts, thus “autonomously”) and to then have a user press a simple finger tab to release the folded, latched support structure assembly from the folded position, whereby it can freely rotate back to the operative, in use position, as fully described in FIGS. 4-5.

First, referring to FIG. 4, is shown a cut away portion of the supported article at 1. First, a support bracket 2 is placed, which provides bilateral pivot openings 4 (one side is elongated vertically at 21-B as described in FIG. 3). The exploded view in FIG. 4 shows both the new folded position support structure assembly release tab, 4, the folded position support structure assembly release finger tab, 26, and shows that the pivot, 3, has specially shaped recesses (pathways, tracks and grooves) on one end of the pivot, 30. (Detailed in the exploded view in FIG. 5). First, the folded position structural support assembly release finger tab is mounted to an inner aspect of the metal bracket 2, by any suitable fixation means. It could alternatively be directly mounted to the supported article. This FIG. 4 shows support structure assembly release tab shaped pivot latching projections 27, and referring back to the folded position support structure assembly release tab, 26, as shown in the exploded view (FIG. 5) it has special shaped pivot latching projections, 27, inside an opening that forms a part of the finger tab, 26. The exploded finger tab, 26, is shown in its mounted position inside the bracket also in FIG. 4, and it is secured to the inner aspect of the bracket, 2, through any suitable fastening method, two such fasteners, 28, are shown in FIG. 4, which serve to fixate the finger tab, 26, through holes in the lower aspect of the finger tab shown at 29. Also, the shape of the finger tab 26 is such that when fixated at the lower mounting point, the finger tab is biased inwardly (inwards towards the interior of the support bracket 2) and the inwards biasing interacts with the pathway recesses and grooves 30 formed in one side of the pivot 3, as depicted in FIG. 5.

Now referring to FIG. 5, which shows the details of the special shaped recess and track pathway area on one end of the pivot 3, denoted at 30 in both FIG. 4 and FIG. 5. As better seen in FIG. 5 in the close up view of this one end of the pivot, 30, with the dash lines above and below the letter A, this shows how the finger tab, 26, has specially placed shaped pivot latching projections, 27. The shape of the finger tab itself once fixated to the bracket 2, without the use of springs, urges the finger tab, 26, towards the center of the pivot, 3.

In use, once a user releases the support structure assembly from the operative, position, and then folds the overall support assembly and case, 5, along the pivot 3 towards the inner portion of the overall supported article, the inward projections, 27, on the finger tab, are biased urged into the track shown in FIG. 5 in between the dash lines closest to the letter A. This latches the overall pivot and optional support case, 5, against free pivoting movement (movement of the support case 5 with internal component parts) but optimally fixating these parts in a latched position between 250 and 290 degrees from the pivot position when these parts are in the operative, latched position of the support shafts 6. As further shown in FIG. 5, if the user seeks to unfold the support structure assembly from its folded, latched position, the movements would be shown by the letter B, that is the user would push the finger tab, 26, toward the outer edge of the pivot, 30, holding the figure tab momentarily outwards or toward the outer edge of the pivot, 30, which thereby allows the release tab shaped pivot latching projections, 27, to move from the shortened track or path shown between the dashed line areas above and below the letter A in FIG. 5, thereby moving the finger tab closer to the outer edge of the pivot, thereby allowing the pivot to freely rotate or pivot as indicated by the letter C, and the upward and downward dashed arrow in FIG. 5. The user only must momentarily move the finger tab outwards as shown at letter B in FIG. 5, because a small incremental turn of the support structure assembly would place the release tab shaped pivot latching projections into the 360 degree, or nearly 360 degree track or pathway 32 shown in FIG. 5 and as further indicated by the letter C. Overall, the addition of the finger tab, 26, allows for latching of any support structure assembly in an inside or folded position, and only requires a momentary movement of the finger tab, 26, by a user, to allow a fold flat support assembly to be moved to an operative, use position.

In review, the releasable pivot retainer, 21, and the folded latching position finger tab part 26 allow for the entire fold flat structural support and associated components, to be constructed in advance of placement into a supported article and through the simple pivoting motion of the releasable pivot retainer, the support assembly and its components can be latched into position in the supported article through simple movement of the quick connect releasable pivot retainer, 21. Also, assuming that the other innovative part, the folded position support structure assembly release tab is first mounted to the bracket, 2, the constructed support structure assembly and pivot can be slid through the bracket side with the finger tab first attached, 26, as shown in FIG. 4. Then as not shown in FIG. 4 or 5, the user can then move or pivot the releasable pivot retainer, 21, down into its operative, use position securing the associated parts, into the bilateral pivot openings 4. It is appreciated that simple minor changes can be made to the described innovations, reversing a protrusion and a recess, slightly changing tracks or pathways and their shapes, reversing projections and recesses, to accomplish the goal of the quick connect of the fold flat support assemblies in bilateral pivot openings, as well as the exact shapes of the recesses pathways and associated shapes of the parts which serve to secure the support assemblies in the folded, latched position without springs or separate parts, and such small changes would be anticipated and derived from the innovations described in this application.

What is claimed is:

1. A support structure assembly operable with a supported article forming a perimeter, which supported article includes at least one pair of bilateral pivot mounting openings oriented horizontally and at least one opening side with an elongated opening, at least one support stand shaft, manually manipulable latching means for securing the support structure to the supported article, a mounting pivot, and a pivot retaining means with a first opened and a second, closed, fixated position, mounted near the at least one elongated pivot opening side of the supported article and in a first assembly phase the support stand shaft is oriented orthogonally to a mounting pivot and an upper terminal end of the support stand shaft travels through an opening in the pivot and is further secured to the pivot with a terminal fixing nut and the pivot is not fixated in both of the bilateral pivot mounting openings in this first phase of assembly and the latching means do not secure the support structure to the supported article in this first, opened position of the pivot retaining means, and in a second phase of assembly one side of the support structure pivot is mounted into one bilateral pivot mounting opening and the opposite side of the pivot is manually manipulated first through the opposite elongated pivot opening and the pivot retaining means is manually moved from the first, opened position to a second, closed fixated position, at least partially surrounding one side of the pivot and securing the pivot against vertical movement within the elongated pivot mounting opening.

2. The support structure of claim 1, wherein a male-female connection between the operative position latch means of the support structure and the supported article provides manually releasable securement of the support structure to the supported article in a first operative position, and in a second, stowed position the latch is released from securement and the support structure components are moved and oriented substantially within the perimeter of the supported article.

3. The support structure of claim 1, wherein at least one wheel is attached to the at least one support shaft providing rolling support to the supported article.

4. The support structure of claim 1, wherein the support stand shaft includes a ground engaging portion allowing sliding movement along a surface.

5. The support structure of claim 1, wherein the at least one support stand shaft is extensible and retractable in a vertical plane between the article perimeter and the support surface.

6. The support structure of claim 1, wherein the at least one support stand shaft is fixated to prevent rotation about the vertical axis of the support stand shaft by a shaped portion of the support stand shaft contacting a corresponding shaped portion of the pivot preventing axial rotation of the support stand shaft about the vertical axis.

7. The support structure of claim 1, wherein the at least one support stand shaft is fixated to prevent rotation about the vertical axis of the support stand shaft by a shaped portion of the support stand shaft contacting a corresponding shaped portion of the movable support structure.

8. A support structure of claim 1, wherein the operative position latching means include a latch block with both a central opening and a lower end having a shaped portion, a spring, and a spring fixation means, and the support stand shaft travels vertically through the central opening in the latch block, through an opening in the spring, and a spring fixation means is mounted to the support shaft which biases the spring downwards towards the latch block, and in a first, operative position the latch block's shaped lower end is oriented through an opening in a portion of the supported article, securing the support shaft orthogonally to the supported article, and in a second, non-operative position the latch block is moved to disengage the latch block's shaped lower portion away from the opening in the supported article.

9. A support structure operable with a supported article forming a perimeter, which supported article includes at least one pair of bilateral pivot mounting openings oriented horizontally, including a manually manipulable stowed position finger tab release, the finger tab release being mounted to the supported article near one of the pivot mounting openings and including a finger tab which includes at least one shaped portion, and at least one support stand shaft, operative position latching means, and a mounting pivot, and near at least one end of the pivot closest to the finger release tab are at least two shaped pathways along the pivot exterior, one pathway having a shorter length than at least one other adjacent longer pathway, and in a first operative position the latching means secures the support structure to the supported article, the support stand shaft is oriented orthogonally to the side elevational profile of the supported article and travels through the pivot, and is further secured to the pivot with a terminal fixing nut providing support for the article in a spaced relationship from a surface, and in a second, stowed position of the support structure, the latching means is manually manipulated allowing the support shaft to be swept inwards to a position substantially within the article perimeter, and the movement and rotation of the pivot along its horizontal orientation autonomously aligns the pivot end with the shorter pathway with a shaped portion of the finger tab latching the support structure against free rotation of the pivot when in the second, stowed position, and, in addition, the stowed position finger tab may be manually manipulated to further orient the at least one shaped portion of the finger tab away from the shorter pivot pathway, into the adjacent longer pivot pathway, permitting selective rotation of the pivot and thereby providing for movement of the support structure from the second, stowed position, back to the first, operative position.

10. The support structure of claim 9, wherein a male-female connection between the operative position latch means of the support structure and the supported article provides manually releasable securement of the support structure to the supported article in a first operative position, and in a second, stowed position the latch is released from securement and the support structure components are moved and oriented substantially within the perimeter of the supported article.

11. The support structure of claim 9, wherein at least one wheel is attached to the at least one support shaft providing rolling support to the supported article.

12. The support structure of claim 9, wherein the support stand shaft includes a ground engaging portion allowing sliding movement along a surface.

13. The support structure of claim 9, wherein the at least one support stand shaft is extensible and retractable in a vertical plane between the article perimeter and the support surface.

14. The support structure of claim 9, wherein the at least one support stand shaft is fixated to prevent rotation about the vertical axis of the support stand shaft by a shaped portion of the support stand shaft contacting a corresponding shaped portion of the pivot preventing axial rotation of the support stand shaft about the vertical axis.

15. The support structure of claim 9, wherein the at least one support stand shaft is fixated to prevent rotation about the vertical axis of the support stand shaft by a shaped portion of the support stand shaft contacting a corresponding shaped portion of the movable support structure.

16. A support structure of claim 9, wherein the operative position latch means include a latch block with both a central opening and a lower end having a shaped portion, a spring, and a spring fixation means, and the support stand shaft travels vertically through the central opening in the latch block, through an opening in the spring, and a spring fixation means is mounted to the support shaft which biases the spring downwards towards the latch block, and in a first, operative position the latch block's shaped lower end is oriented through an opening in a portion of the supported article, securing the support shaft orthogonally to the supported article, and in a second, non-operative position the latch block is moved to disengage the latch block's shaped lower portion away from the opening in the supported article.
